(19) United States
(12) Patent Application Publication
(10) Pub. No.: US 2022/0057795 A1
(43) Pub. Date: Feb. 24, 2022

(54) DRIVE CONTROL DEVICE, DRIVE CONTROL METHOD, AND COMPUTER PROGRAM PRODUCT

(71) Applicant: KABUSHIKI KAISHA TOSHIBA, Tokyo (JP)

(72) Inventors: Rie KATSUKI, Kawasaki (JP); Toshimitsu KANEKO, Kawasaki (JP); Masahiro SEKINE, Fuchu (JP)

(73) Assignee: KABUSHIKI KAISHA TOSHIBA, Tokyo (JP)

(21) Appl. No.: 17/186,973

(22) Filed: Feb. 26, 2021

(30) Foreign Application Priority Data
Aug. 18, 2020 (JP) 2020-137925

(51) Int. Cl. G05D 1/00; B60W 60/00; B60W 50/14; G05D 1/02

(52) U.S. Cl. CPC G05D 1/0061; G05D 1/0223; B60W 50/14; B60W 60/0053

(57) ABSTRACT

According to an embodiment, a drive control device includes a generation unit configured to generate autonomous driving control information to control a behavior of a mobile object using autonomous driving; a prediction unit configured to predict a behavior of the mobile object when switching from the autonomous driving to manual driving; a determination unit configured to determine a difference between the behavior of the mobile object controlled by the autonomous driving control information and the behavior of the mobile object when the switching to the manual driving is made; an output control unit configured to output information that prompts a driver of the mobile object to select the autonomous driving or the manual driving, when the difference is present; and a power control unit configured to control a power unit of the mobile object using the autonomous driving or the manual driving.

### CROSS-REFERENCE TO RELATED APPLICATIONS

This application is based upon and claims the benefit of priority from Japanese Patent Application No. 2020-137925, filed on Aug. 18, 2020; the entire contents of which are incorporated herein by reference.

### FIELD

Embodiments described herein relate generally to a drive control device, a drive control method, and a computer program product.

### BACKGROUND

Technologies regarding autonomous driving of mobile objects such as vehicles are conventionally known. For example, technologies are conventionally known in which a safety monitoring system of a vehicle during autonomous driving monitors driving conditions for a potentially unsafe condition, and when determining that the unsafe condition is present, prompts a driver of the vehicle to take over the driving operation.

### BRIEF DESCRIPTION OF THE DRAWINGS

FIG. 1 is a diagram illustrating an example of a mobile object according to a first embodiment;

FIG. 2 is a diagram illustrating an example of the functional configuration of the mobile object according to the first embodiment;

FIG. 3 is a diagram for explaining an operation example of a processing unit according to the first embodiment;

FIG. 4 is a diagram for explaining an example of processing to determine a difference in driving action according to the first embodiment;

FIG. 5 is a flowchart illustrating the example of the processing to determine the difference in the driving action according to the first embodiment;

FIG. 6 is a diagram for explaining an example of processing to determine a difference in trajectory according to the first embodiment;

FIG. 7 is a flowchart illustrating the example of the processing to determine the difference in the trajectory according to the first embodiment;

FIG. 8 is a flowchart illustrating an example of processing at Step S22;

FIG. 9 is a diagram illustrating a configuration example of networks for determining the difference in the trajectory according to the first embodiment;

FIG. 10 is a diagram illustrating Example 1 of output information according to the first embodiment;

FIG. 11 is a diagram illustrating Example 2 of the output information according to the first embodiment;

FIG. 12 is a diagram illustrating Example 3 of the output information according to the first embodiment;

FIG. 13 is a diagram illustrating Example 4 of the output information according to the first embodiment;

FIG. 14 is a diagram illustrating Example 5 of the output information according to the first embodiment;

FIG. 15 is a diagram illustrating Example 6 of the output information according to the first embodiment;

FIG. 16 is a diagram for explaining an operation example of a processing unit according to a second embodiment; and

FIG. 17 is a diagram illustrating an example of a hardware configuration of a main part of a drive control device according to the first and second embodiments.

### DETAILED DESCRIPTION

According to an embodiment, a drive control device includes a generation unit, a prediction unit, a determination unit, an output control unit, and a power control unit. The generation unit is configured to generate autonomous driving control information to control a behavior of a mobile object using autonomous driving. The prediction unit configured to predict a behavior of the mobile object when switching from the autonomous driving to manual driving. The determination unit is configured to determine a difference between the behavior of the mobile object controlled to be automatically driven using the autonomous driving control information and the behavior of the mobile object when the switching to the manual driving is made. The output control unit is configured to output, to an output unit, information that prompts a driver of the mobile object to select the autonomous driving or the manual driving, when the difference is present. The power control unit configured to control a power unit of the mobile object using the autonomous driving or the manual driving.

The following describes embodiments of a drive control device, a drive control method, and a computer program in detail with reference to the accompanying drawings.

### First Embodiment

A drive control device according to a first embodiment is mounted on, for example, a mobile object.

Example of Mobile Object

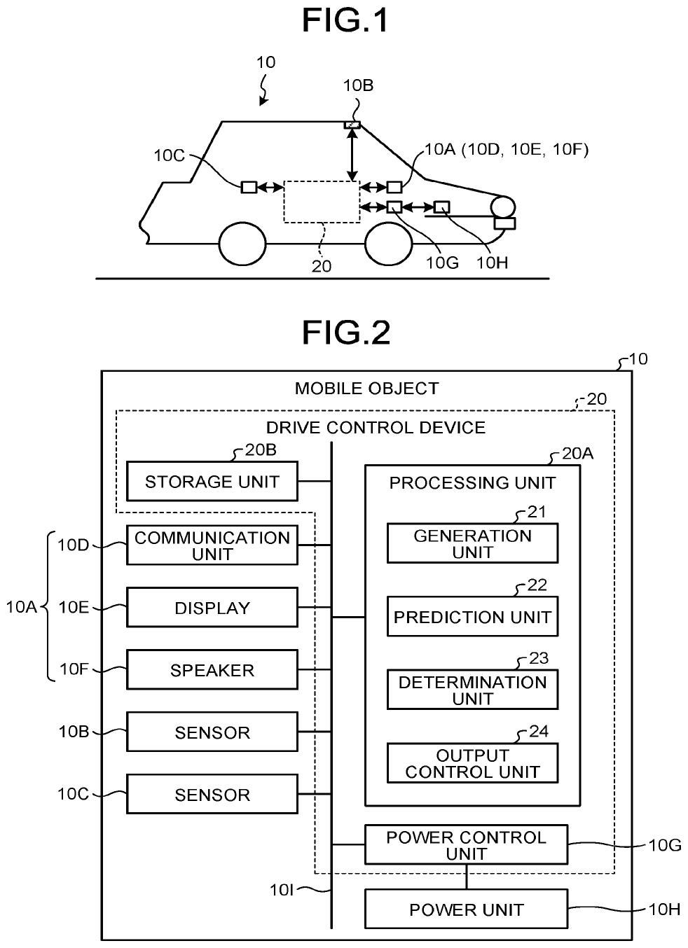

FIG. 1 is a diagram illustrating an example of a mobile object 10 according to the first embodiment.

The mobile object 10 includes a drive control device 20, an output unit 10A, a sensor 10B, sensors 10C, a power control unit 10G, and a power unit 10H.

The mobile object 10 may be any mobile object. The mobile object 10 is, for example, a vehicle, a drone, a watercraft, a wheeled platform, or an autonomous mobile robot. The vehicle is, for example, a two-wheeled motor vehicle, a four-wheeled motor vehicle, and a bicycle. The mobile object 10 according to the first embodiment is a mobile object that can travel under manual driving via a human driving operation, and can travel (autonomously travel) under autonomous driving without the human driving operation.

The drive control device 20 is configured, for example, as an electronic control unit (ECU).

The drive control device 20 is not limited to a mode of being mounted on the mobile object 10. The drive control device 20 may be mounted on a stationary object. The stationary object is an immovable object such as an object fixed to a ground surface. The stationary object fixed to the ground surface is, for example, a guard rail, a pole, a parked vehicle, or a traffic sign. The stationary object is, for example, an object in a static state with respect to the ground surface. The drive control device 20 may be mounted on a cloud server that executes processing on a cloud system.

The power unit 10H is a drive device mounted on the mobile object 10. The power unit 10H is, for example, an engine, a motor, and wheels.

The power control unit 10G controls driving of the power unit 10H.

The output unit 10A outputs information. The output unit 10A includes at least one of a communication function to transmit the information, a display function to display the information, and a sound output function to output a sound indicating the information. The first embodiment will be described by way of an example of a configuration in which the output unit 10A includes a communication unit 10D, a display 10E, and a speaker 10F.

The communication unit 10D transmits the information to other devices. The communication unit 10D transmits the information to the other devices, for example, through communication lines. The display 10E displays the information. The display 10E is, for example, a liquid crystal display (LCD), a projection device, or a light. The speaker 10F outputs a sound representing the information.

The sensor 10B is a sensor that acquires information on the periphery of the mobile object 10. The sensor 10B is, for example, a monocular camera, a stereo camera, a fisheye camera, an infrared camera, a millimeter-wave radar, or a light detection and ranging or laser imaging detection and ranging (LIDAR) sensor. In the description herein, a camera will be used as an example of the sensor 10B. The number of the cameras (10B) may be any number. A captured image may be a color image consisting of three channels of red, green, and blue (RGB) or a monochrome image having one channel represented as a gray scale. The camera (10B) captures time-series images at the periphery of the mobile object 10. The camera (10B) captures the time-series images, for example, by imaging the periphery of the mobile object 10 in chronological order. The periphery of the mobile object 10 is, for example, a region within a predefined range from the mobile object 10. This range is, for example, a range capturable by the camera (10B).

The first embodiment will be described by way of an example of a case where the camera (10B) is installed so as to include a front direction of the mobile object 10 as an imaging direction. That is, in the first embodiment, the camera (10B) captures the images in front of the mobile object 10 in chronological order.

The sensors 10C are sensors that measure a state of the mobile object 10. The measurement information includes, for example, the speed of the mobile object 10 and a steering wheel angle of the mobile object 10. The sensors 10C are, for example, an inertial measurement unit (IMU), a speed sensor, and a steering angle sensor. The IMU measures the measurement information including triaxial accelerations and triaxial angular velocities of the mobile object 10. The speed sensor measures the speed based on rotation amounts of tires. The steering angle sensor measures the steering wheel angle of the mobile object 10.

The following describes an example of a functional configuration of the mobile object 10 according to the first embodiment.

Example of Functional Configuration

FIG. 2 is a diagram illustrating an example of the functional configuration of the mobile object 10 according to the first embodiment. The first embodiment will be described by way of an example of a case where the mobile object 10 is the vehicle.

The mobile object 10 includes the output unit 10A, the sensors 10B and 10C, the power unit 10H, and the drive control device 20. The output unit 10A includes the communication unit 10D, the display 10E, and the speaker 10F. The drive control device 20 includes the power control unit 10G, a processing unit 20A, and a storage unit 20B.

The processing unit 20A, the storage unit 20B, the output unit 10A, the sensor 10B, the sensors 10C, and the power control unit 10G are connected together through a bus 10I. The power unit 10H is connected to the power control unit 10G.

The output unit 10A (the communication unit 10D, the display 10E, and the speaker 10F), the sensor 10B, the sensors 10C, the power control unit 10G, and the storage unit 20B may be connected together through a network. The communication method of the network used for the connection may be a wired method or a wireless method. The network used for the connection may be implemented by combining the wired method with the wireless method.

The storage unit 20B stores therein information. The storage unit 20B is, for example, a semiconductor memory device, a hard disk, or an optical disc. The semiconductor memory device is, for example, a random-access memory (RAM) or a flash memory. The storage unit 20B may be a storage device provided outside the drive control device 20. The storage unit 20B may be a storage medium. Specifically, the storage medium may be a medium that stores or temporarily stores therein computer programs and/or various types of information downloaded through a local area network (LAN) or the Internet. The storage unit 20B may be constituted by a plurality of storage media.

The processing unit 20A includes a generation unit 21, a prediction unit 22, a determination unit 23, and an output control unit 24. The processing unit 20A (the generation unit 21, the prediction unit 22, the determination unit 23, and the output control unit 24) are implemented by, for example, one processor or a plurality of processors.

The processing unit 20A may be implemented, for example, by causing a processor such as a central processing unit (CPU) to execute a computer program, that is, by software. Alternatively, the processing unit 20A may be implemented, for example, by a processor such as a dedicated integrated circuit (IC), that is, by hardware. The processing unit 20A may also be implemented, for example, using both software and hardware.

The term “processor” used in the embodiments includes, for example, a CPU, a graphical processing unit (GPU), an application-specific integrated circuit (ASIC), and a programmable logic device. The programmable logic device includes, for example, a simple programmable logic device (SPLD), a complex programmable logic device (CPLD), and a field-programmable gate array (FPGA).

The processor reads and executes a computer program stored in the storage unit 20B to implement the processing unit 20A. Instead of storing the computer program in the storage unit 20B, the computer program may be directly incorporated in the circuit of the processor. In that case, the processor reads and executes the computer program incorporated in the circuit to implement the processing unit 20A.

The power control unit 10G may also be implemented by the processing unit 20A.

The following describes functions of the processing unit 20A.

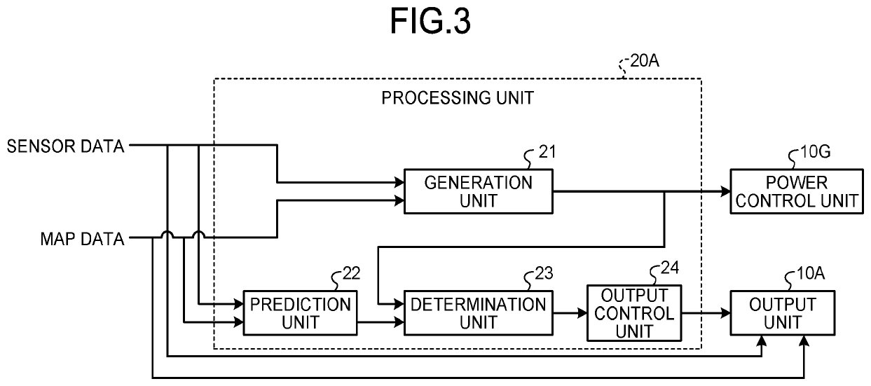

FIG. 3 is a diagram for explaining an operation example of the processing unit 20A according to the first embodiment. The generation unit 21 acquires sensor data from the sensors 10B and 10C, and acquires map data from, for example, the communication unit 10D and a storage unit 20D.

The map data includes, for example, travelable ranges, reference paths (lines drawn in the centers of lanes recommended to be followed), traffic rules (road markings, traffic signs, legal speed limits, and positions of traffic lights), and structures.

The sensor data includes, for example, states (position, attitude, speed, and acceleration) of the mobile object 10, predicted trajectories of obstacles (such as pedestrians and vehicles), and a state of a signal of a traffic light.

The generation unit 21 generates autonomous driving control information for controlling a behavior of the mobile object using the autonomous driving. The autonomous driving control information includes at least one of a driving action such as overtaking, following, or stopping, a trajectory, and a path. The trajectory is data representing a sequence of information (for example, waypoints) representing the positions and the attitudes of the mobile object 10 using time information as a parameter. The path is data obtained by deleting the time information from the trajectory.

The autonomous driving control information including the driving action can be generated using, for example, a method described in Soren Kammel, Julius Ziegler, Benjamin Pitzer, Moritz Werling, Tobias Gindele, Daniel Jagzent, et al., “Team AnnieWAY's Autonomous System for the 2007 DARPA Urban Challenge”, Journal of Field Robotics, 25(9), pp. 615-639, 2008. The autonomous driving control information including the trajectory can be generated using, for example, a method described in Wenda Xu, Junqing Wei, John M. Dolan, Huijing Zhao, Hongbin Zha, “A Real-Time Motion Planner with Trajectory Optimization for Autonomous Vehicles”, Proceedings of IEEE International Conference on Robotics and Automation, pp. 2061-2067, 2012. The generation unit 21 supplies the generated autonomous driving control information to the power control unit 10G.

The prediction unit 22 predicts the behavior of the mobile object 10 when switching from the autonomous driving to the manual driving is made during the autonomous driving. An example of a method for predicting the behavior of the mobile object 10 when switching from the autonomous driving to the manual driving is made will be described in a second embodiment.

The determination unit 23 determines a difference between the behavior of the mobile object 10 controlled to be automatically driven using the autonomous driving control information and the behavior of the mobile object 10 when switching to the manual driving is made. The determination unit 23 determines the difference based on at least one of the driving action of the mobile object 10, the path followed by the mobile object 10, and the trajectory of the mobile object 10.

The output control unit 24 controls output of output information output to the output unit 10A. The output information includes, for example, an obstacle, a travelable range, the traffic signs, the road markings, and the driving action (for example, the stopping). If the determination unit 23 has determined that the difference is present, the output control unit 24 outputs the output information including, for example, a message prompting a driver of the mobile object 10 to select the autonomous driving or the manual driving and a message recommending the switching to the manual driving to the output unit 10A.

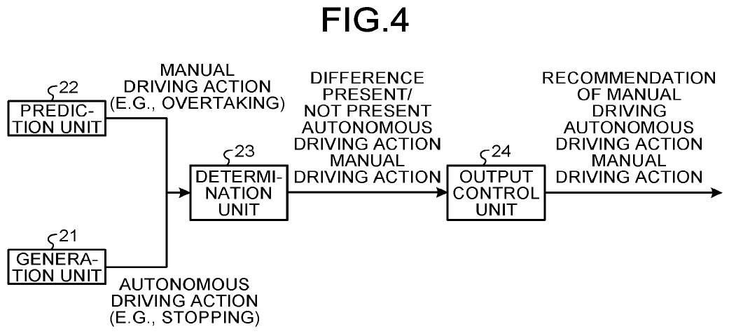

FIG. 4 is a diagram for explaining an example of processing to determine the difference in the driving action according to the first embodiment. The determination unit 23 receives information representing an autonomous driving action (for example, the stopping) from the generation unit 21, and receives information representing a manual driving action (for example, the overtaking) from the prediction unit 22. The determination unit 23 determines the difference between the autonomous driving action and the manual driving action, and supplies information including, for example, whether the difference is present, the autonomous driving action, and the manual driving action to the output control unit 24. The output control unit 24 outputs the output information including, for example, the recommendation of the manual driving, the autonomous driving action, and the manual driving action to the output unit 10A. The processing to determine whether to recommend the manual driving may be performed by the determination unit 23 or the output control unit 24.

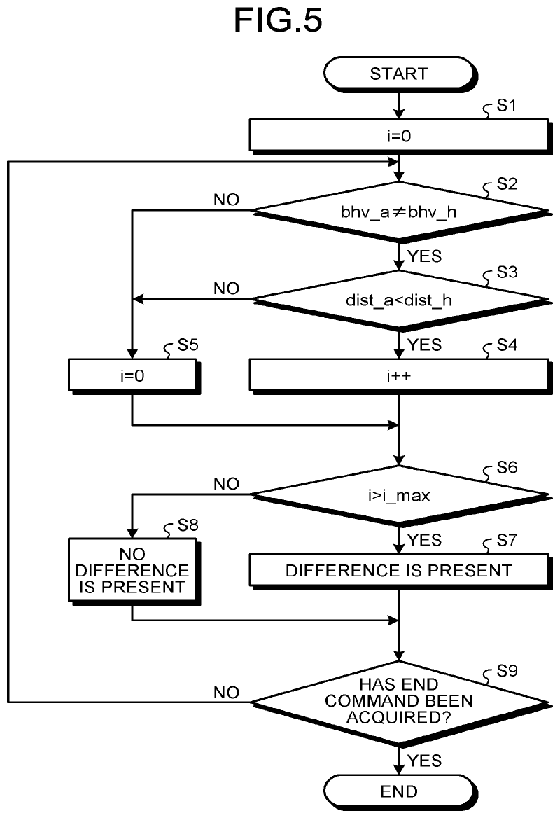

FIG. 5 is a flowchart illustrating the example of the processing to determine the difference in the driving action according to the first embodiment. First, the determination unit 23 sets i to 0 (Step S1). The determination unit 23 then determines whether bhv_a≠bhv_h (Step S2). In this expression, the term bhv_a denotes the driving action of the autonomous driving generated by the generation unit 21. The term bhv_h denotes the driving action of the manual driving predicted by the prediction unit 22 in the state at the time of the determination at Step S2.

If bhv_a≠bhv_h holds (Yes at Step S2), the determination unit 23 determines whether dist_a<dist_h (Step S3). In this expression, the term dist_a denotes a travel distance when the autonomous driving generated by the generation unit 21 is performed. The term dist_h denotes a travel distance predicted by the prediction unit 22 when the manual driving is performed in the state at the time of the determination at Step S3.

If dist_a<dist_h (Yes at Step S3), the determination unit 23 increments i (adds 1 to i) (Step S4), and the process goes to Step S6.

If bhv_a≠bhv_h does not hold (No at Step S2) or if dist_a<dist_h does not hold (No at Step S3), that is, if bhv_a=bhv_h or if dist_a≥dist_h, the determination unit 23 sets i to 0 (Step S5), and performs processing at Step S6.

The determination unit 23 then determines whether i>i_max (Step S6). In this expression, the term i_max is a threshold for determining the value of i. If i>i_max (Yes at Step S6), the determination unit 23 determines that a difference is present in the driving action (Step S7), or if i≤i_max (No at Step S6), the determination unit 23 determines that no difference is present in the driving action (Step S8).

That is, the determination unit 23 determines that the difference is present in the driving action if the number of times for which the two conditions of the difference in the driving action (bhv_a≠bhv_h) and the difference in the travel distance (dist_a<dist_h) are successively satisfied is larger than i_max. The reason why i_max is set is that fluctuations are to be prevented from being taken into account in the determination of whether to select the manual or autonomous driving action. Specifically, if the determination of whether to select the manual or autonomous driving action differs each time the determination is made, the recommendation result of the manual driving (recommended/not recommended) often changes (the determination fluctuates). To restrain this fluctuation, the driving action is determined to have the difference only when the difference in the driving action is successively present the number of times larger than i_max.

Then, the determination unit 23 determines whether an end command of the determination processing has been acquired (Step S9). The end command of the determination processing is acquired in response to, for example, an operational input from a user who no longer needs the output information (for example, display information and a voice guidance), for example, to recommend the switching from the autonomous driving to the manual driving. If the end command has been acquired (Yes at Step S9), the process ends. If the end command has not been acquired (No at Step S9), the process returns to Step S2.

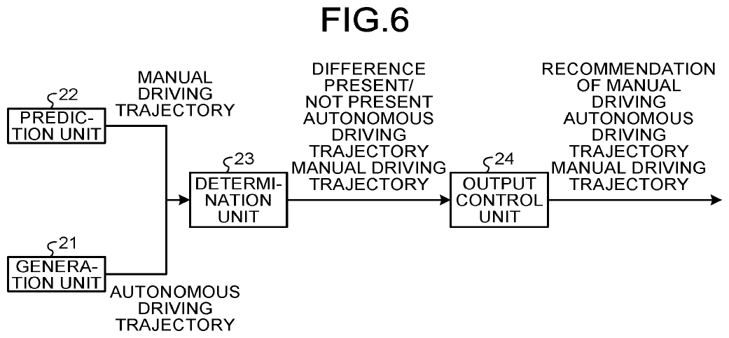

FIG. 6 is a diagram for explaining an example of processing to determine a difference in trajectory according to the first embodiment. The determination unit 23 receives information representing an autonomous driving trajectory from the generation unit 21, and receives information representing a manual driving trajectory from the prediction unit 22. The determination unit 23 determines a difference between the autonomous driving trajectory and the manual driving trajectory, and supplies the information including, for example, whether the difference is present, the autonomous driving trajectory, and the manual driving trajectory to the output control unit 24. The output control unit 24 outputs the output information including, for example, the recommendation of the manual driving, the autonomous driving trajectory, and the manual driving trajectory to the output unit 10A.

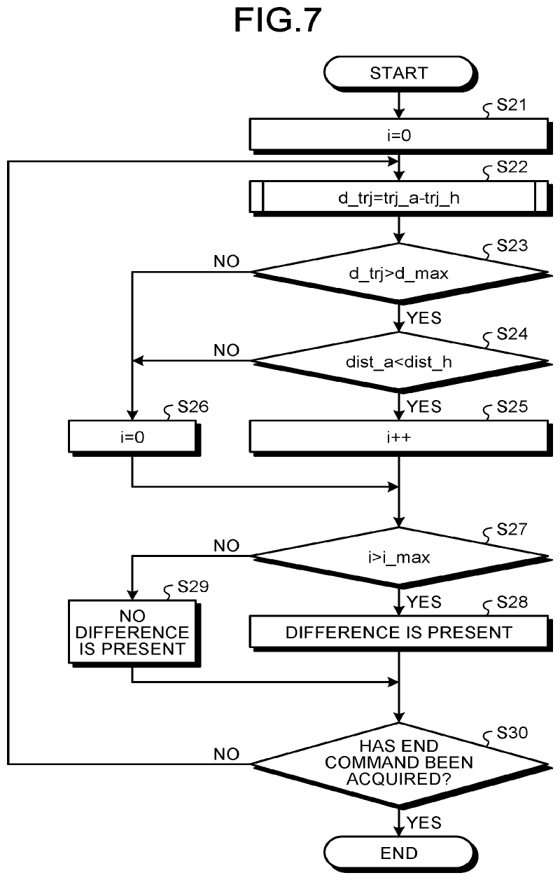

FIG. 7 is a flowchart illustrating the example of the processing to determine the difference in the trajectory according to the first embodiment. First, the determination unit 23 sets i to 0 (Step S21).

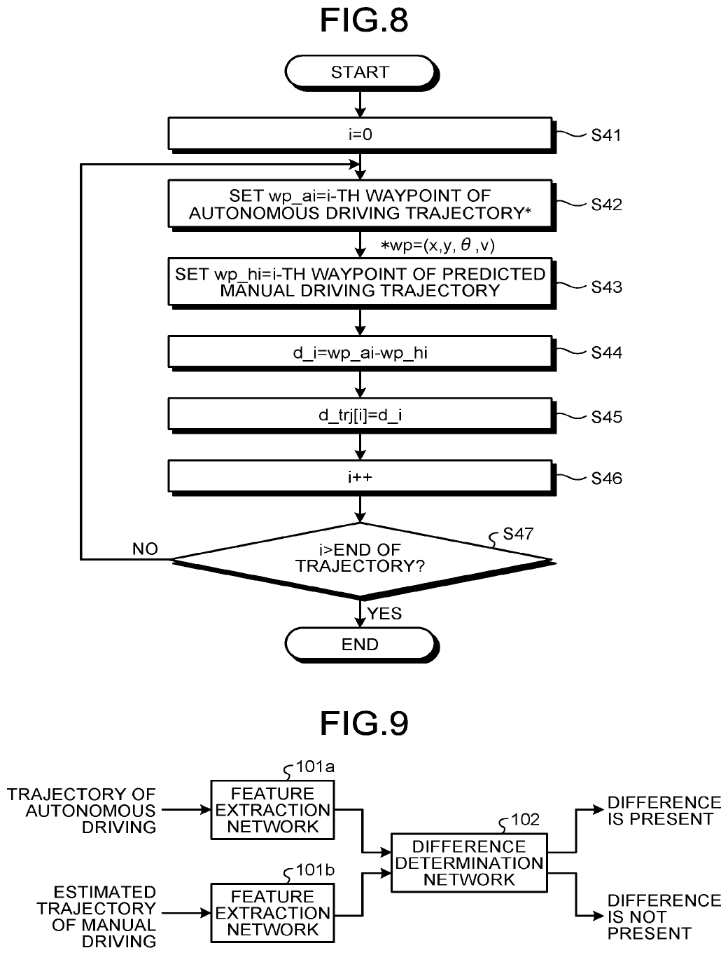

The determination unit 23 then calculates d_trj=trj_a−trj_h (Step S22). In this expression, the term trj_a denotes the trajectory of the mobile object 10 generated by the generation unit 21 when the autonomous driving is performed. The term trj_h denotes the trajectory of the mobile object 10 predicted by the prediction unit 22 when the manual driving is performed in the state at the time of the processing at Step S22. The term d_trj denotes the difference between the trajectory of the mobile object 10 if the autonomous driving is performed and the trajectory of the mobile object 10 when the manual driving is performed. Details of the processing at Step S22 will be described later with reference to FIG. 8.

Then, the determination unit 23 determines whether d_trj>d_max (Step S23). In this expression, the term d_max is a threshold value for determining the value of d_trj.

If d_trj>d_max (Yes at Step S23), the determination unit 23 determines whether dist_a<dist_h (Step S24). In this expression, the term dist_a denotes the travel distance when the autonomous driving generated by the generation unit 21 is performed. The term dist_h denotes the travel distance predicted by the prediction unit 22 when the manual driving is performed in the state at the time of the determination at Step S24.

If dist_a<dist_h (Yes at Step S24), the determination unit 23 increments i (adds 1 to i) (Step S25), and the process goes to Step S27.

If d_trj>d_max does not hold (No at Step S23) or if dist_a<dist_h does not hold (No at Step S24), the determination unit 23 sets i to 0 (Step S5), and performs processing at Step S27.

The determination unit 23 then determines whether i>i_max (Step S27). In this expression, the term i_max is the threshold value for determining the value of i. If i>i_max (Yes at Step S27), the determination unit 23 determines that the difference is present in the driving action (Step S28), or if i≤i_max (No at Step S27), the determination unit 23 determines that no difference is present in the driving action (Step S29).

That is, the determination unit 23 determines that the difference is present in the trajectory if the number of times for which the two conditions (the differential in the trajectory is larger than the threshold value (d_trj>d_max), and the travel distance by the autonomous driving is smaller than the travel distance by the manual driving (dist_a<dist_h)) are successively satisfied is larger than i_max.

Then, the determination unit 23 determines whether the end command of the determination processing has been acquired (Step S9). The end command of the determination processing is acquired in response to, for example, the operational input from the user who no longer needs the output information (for example, the display information and the voice guidance), for example, to recommend the switching from the autonomous driving to the manual driving. If the end command has been acquired (Yes at Step S30), the process ends. If the end command has not been acquired (No at Step S30), the process returns to Step S22.

FIG. 8 is a flowchart illustrating an example of the processing at Step S22. First, the determination unit 23 sets i to 0 (Step S41).

The determination unit 23 then sets the i-th waypoint of the autonomous driving trajectory at wp_ai (Step S42). The waypoint of the autonomous driving trajectory is represented as, for example, wp=(x, y, θ, v). In this expression, x and y denote coordinates of the mobile object 10; θ denotes an angle (of, for example, steering) representing the attitude of the mobile object 10; and v denotes the speed of the mobile object 10.

Then, the determination unit 23 sets the i-th waypoint of the manual driving trajectory at wp_hi (Step S43).

The determination unit 23 then calculates a difference d_i=wp_ai−wp_hi between wp_ai and wp_hi (Step S44). The difference, d_i, is determined by taking a difference between at least one of x, y, θ, and v included in wp_ai and at least one of x, y, θ, and v included in wp_hi. The determination unit 23 then sets d_trj[i] to d_i (Step S45). The determination unit 23 then increments i (adds 1 to i) (Step S46).

The determination unit 23 then determines whether i is larger than j representing an end d_trj[j] of the trajectory (Step S47). If i is equal to or smaller than j representing the end d_trj[j] of the trajectory (No at Step S47), the process returns to Step S42. If i is larger than j representing the end d_trj[j] of the trajectory (Yes at Step S47), the process ends.

The term d_trj at Step S22 described above is calculated as Σd_trj[i]. The processing of the above-described flowcharts in FIGS. 7 and 8 may be performed replacing the trajectory of the mobile object 10 with the path of the mobile object 10. The trajectories may be used for the difference determination, and the determination result may be used as a travel trajectory not including the time information (that is, a path).

The determination unit 23 may use a machine learning model (neural network) to determine the difference between the trajectory in the case where the autonomous driving is continued and the predicted trajectory in the case where switching from the autonomous driving to the manual driving is made.

FIG. 9 is a diagram illustrating a configuration example of networks for determining the difference in the trajectory according to the first embodiment. The determination unit 23 uses, for example, feature extraction networks 101a and 101b and a difference determination network 102 to determine the difference between the trajectory of the autonomous driving and the predicted trajectory of the manual driving. The feature extraction network 101a is a network that extracts a feature of the trajectory of the autonomous driving. The feature extraction network 101b is a network that extracts a feature of the predicted trajectory of the manual driving. The difference determination network 102 is a network that determines whether a difference is present between the two features extracted by the feature extraction networks 101a and 101b. The features herein refer to data required for the determination of the difference between the trajectory of the autonomous driving and the predicted trajectory of the manual driving. The data representing the features is automatically extracted, including a definition of the data, by the feature extraction networks 101a and 101b.

In the case where what is to be determined is the path instead of the trajectory, the determination can be made using the same machine learning model (neural network) as in the case of the trajectory.

Examples of Output Information

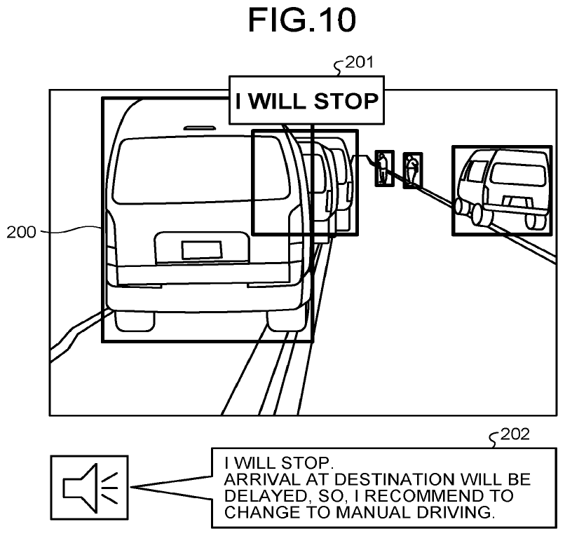

FIG. 10 is a diagram illustrating Example 1 of the output information according to the first embodiment. FIG. 10 illustrates an example of the output information when a determination has been made that, although an own vehicle (mobile object 10) can travel in the case of the manual driving, the own vehicle cannot travel (stops) due to an insufficient safety margin between an obstacle 200 and the own vehicle in the case of the autonomous driving. In the output information of FIG. 10, information 201 indicating a driving action (“I will stop”) is highlighted, for example, by being blinked, by being colored in red, and/or by being displayed in a bold font. The output information of FIG. 10 includes a message 202 that tells the occupant in the vehicle a reason for recommending the manual driving. The message 202 may be output using a voice or display information.

The message 202 is output by, for example, the following processing. First, the determination unit 23 determines a time required to reach a destination (target place) using the autonomous driving and a time required to reach the destination when switching to the manual driving is made. If the time required to reach the destination when switching to the manual driving is made is shorter than the time required to reach the destination using the autonomous driving, the output control unit 24 outputs the message 202 indicating that the manual driving enables reaching the destination earlier to the output unit 10A.

Under the situation of, for example, FIG. 10, the mobile object 10 excessively guaranteed for safety may fail to harmonize with surrounding vehicles (for example, vehicles in front or behind that are manually being driven), and may disturb a traffic flow. By outputting the above-described message 202, the switching from the autonomous driving to the manual driving is prompted, and thereby, the mobile object safely controlled to be automatically driven can be prevented from disturbing the traffic flow.

If the driving action of the mobile object 10 controlled to be automatically driven is stopping, and if the driving action of the mobile object 10 in the case where switching to the manual driving is made is an action other than the stopping (driving action capable of traveling without stopping), the output control unit 24 may output the output information for receiving setting of the safety margin between the obstacle 200 and the mobile object to the output unit 10A. In this case, the generation unit 21 uses the set safety margin to regenerate the autonomous driving control information. If the driving action indicated by the regenerated autonomous driving control information is the action other than the stopping, the power control unit 10G controls the power unit 10H according to the regenerated autonomous driving control information.

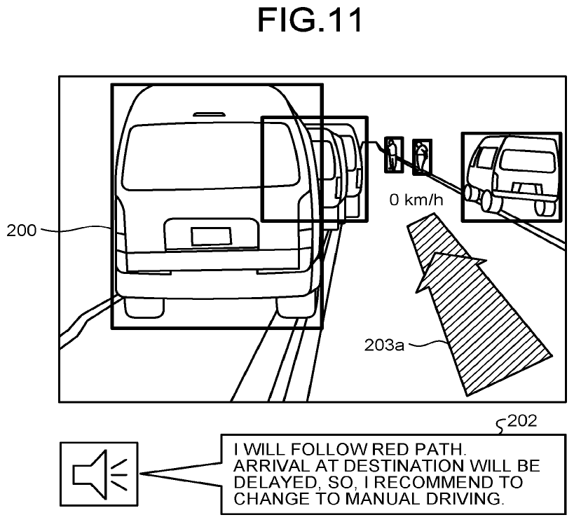

FIG. 11 is a diagram illustrating Example 2 of the output information according to the first embodiment. FIG. 11 illustrates an example of the output information including information 203a that represents the trajectory (path) and the speed (0 km/h) at an end position thereof, of the autonomous driving. The information 203a is displayed, for example, in red. Outputting the trajectory (path) of the autonomous driving can identify the travelable range of the mobile object 10. The speed may be displayed not only for the end position, but also for a plurality of positions on the path. For example, the output control unit 24 outputs the path and the speed of the mobile object 10 as the display information, and outputs the message 202 using the voice. Through this operation, the occupant of the mobile object 10 is informed of a possibility that the autonomous driving may delay the arrival at the target place (destination), and is prompted to perform the switching to the manual driving. Outputting the message 202 facilitates the occupant to determine the switching to the manual driving.

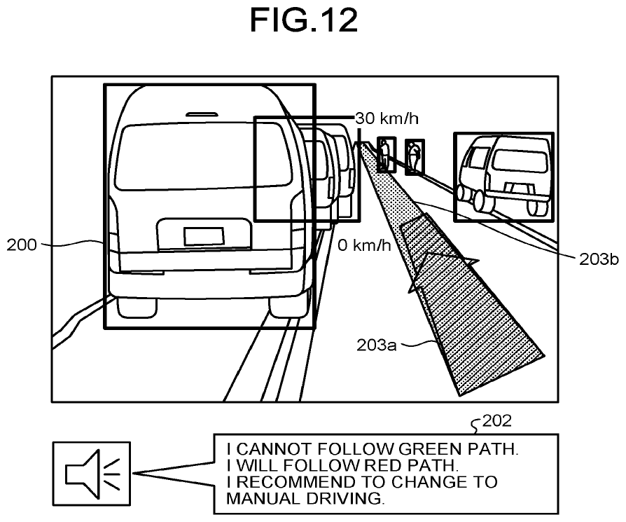

FIG. 12 is a diagram illustrating Example 3 of the output information according to the first embodiment. FIG. 12 illustrates an example of the output information including the information 203a that represents the trajectory (path) and the speed (0 km/h) at the end position thereof, of the autonomous driving, and information 203b that represents the trajectory (path) and the speed (30 km/h) at an end position thereof, of the manual driving. The information 203a is displayed, for example, in red, and the information 203b is displayed, for example, in green. At least one of the pieces of the information 203a and 203b may be highlighted, for example, by being blinked. Presenting the trajectory of the autonomous driving and the trajectory of the manual driving to the occupant can facilitate the occupant to determine the switching to the manual driving. The output control unit 24 also displays the message 202 that recommends, for example, to manually drive on a manual driving path (green path) instead of driving on an autonomous driving path (red path). Alternatively, for example, the output control unit 24 may output the output information for outputting alternatives for selection of whether to continue the manual driving or to switch to the autonomous driving, and receiving a selection from the occupant.

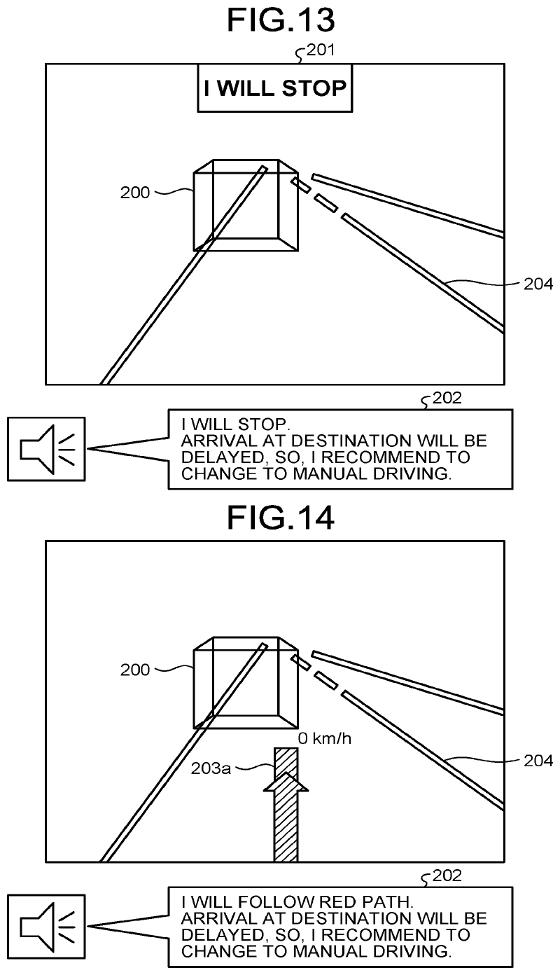

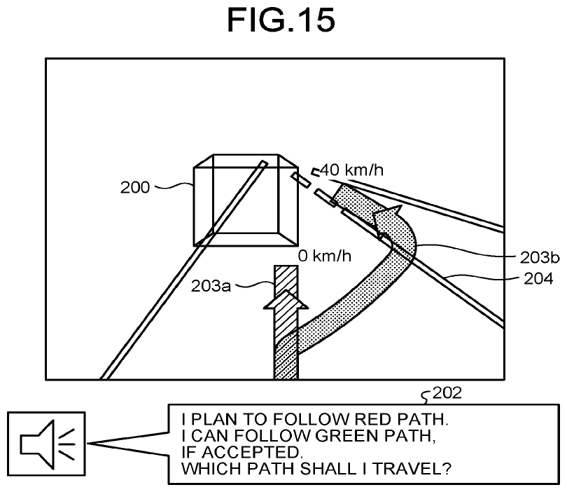

FIG. 13 is a diagram illustrating Example 4 of the output information according to the first embodiment. FIG. 14 is a diagram illustrating Example 5 of the output information according to the first embodiment. FIG. 15 is a diagram illustrating Example 6 of the output information according to the first embodiment. Although in FIGS. 10 to 12, recognition results and computer graphics (CG) images of the autonomous driving trajectory and the manual driving trajectory are layered on the image, FIGS. 13 to 15 display only the CG images. Whether to layer the image and the CG images is determined according to the cost of development, and has no relation with the situation of driving (for example, stopping or overtaking). FIGS. 13 and 14 illustrate examples of the output information in a situation where the autonomous driving cannot be continued because if the autonomous driving is continued, a portion of the autonomous driving path will cross over a white solid line 204 (line crossing prohibited).

In the example of FIG. 13, the output information including the information 201 indicating the driving action (“I stop”) is output. In the example of FIG. 14, the output information is output that includes the information 203a representing the trajectory (path) and the speed (0 km/h) at the end position thereof, of the autonomous driving. FIGS. 13 and 14 are examples of the output information that is output on the assumption that the manual driving path is not achieved by the autonomous driving.

In contrast, in the example of FIG. 15, the output information is output that includes the information 203a representing the trajectory (path) and the speed (0 km/h) at the end position thereof, of the autonomous driving, and the information 203b representing the trajectory (path) and the speed (40 km/h) at the end position thereof, of the manual driving, and the message 202 asks the occupant which path is to be followed by the autonomous driving. If accepted, the mobile object 10 may be controlled so as to be capable of traveling on the manual driving path using the autonomous driving, as illustrated in FIG. 15. Specifically, if the autonomous driving uses the path or the trajectory of the mobile object 10 when manually driven, the generation unit 21 regenerates the autonomous driving control information based on the path or the trajectory of the mobile object 10 when manually driven. The power control unit 10G controls the power unit 10H according to the regenerated autonomous driving control information.

When the output control unit 24 outputs the output information illustrated in FIGS. 10 to 15 described above, the output control unit 24 may output at least one of the information 201 indicating the driving action of the autonomous driving; the speed, the path, or the trajectory of the mobile object 10 when automatically driven (for example, the above-described information 203a); and the speed, the path, or the trajectory of the mobile object 10 when manually driven (for example, the above-described information 203b) in a highlighted manner.

As described above, in the drive control device 20 according to the first embodiment, the generation unit 21 generates the autonomous driving control information for controlling the behavior of the mobile object 10 using the autonomous driving. The prediction unit 22 predicts the behavior of the mobile object when switching from the autonomous driving to the manual driving is made. The determination unit 23 determines the difference between the behavior of the mobile object controlled to be automatically driven using the autonomous driving control information and the behavior of the mobile object when switching to the manual driving is made. If the difference is present, the output control unit 24 outputs the information that prompts the driver of the mobile object 10 to select the autonomous driving or the manual driving to the output unit 10A. The power control unit 10G controls the power unit 10H of the mobile object 10 using the autonomous driving or the manual driving.

Thus, the drive control device 20 according to the first embodiment can prevent the mobile object 10 safely controlled to be automatically driven from disturbing the traffic flow. Specifically, since the determination unit 23 can determine the difference between the behavior of the mobile object 10 predicted when switching to the manual driving is made and the behavior of the mobile object 10 when the autonomous driving control is continued, the occupant can be prompted to select the manual driving when the efficiency of the manual driving is higher. The manual driving can be employed as appropriate even during the autonomous driving of the mobile object 10, whereby a bottleneck in movement is removed, and the efficient driving is enabled while the traffic flow is not disturbed.

### Second Embodiment

The following describes a second embodiment. In the description of the second embodiment, the same description as that of the first embodiment will not be repeated, and portions different from those of the first embodiment will be described.

In the second embodiment, a case will be described where the prediction unit 22 imitatively learns the manual driving, and uses an imitation learning result thereof for the generation processing of the autonomous driving control information by the generation unit 21.

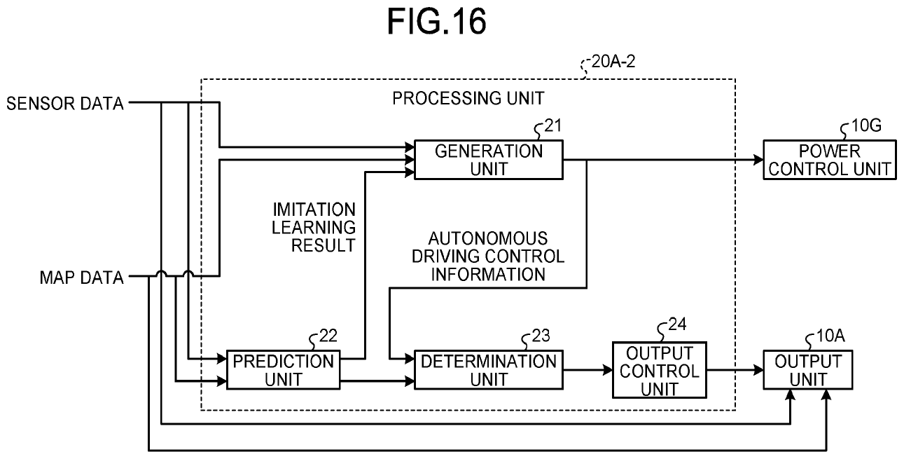

FIG. 16 is a diagram for explaining an operation example of a processing unit 20A-2 according to the second embodiment. The manual driving to be imitatively learned includes at least one of the driving action (for example, the overtaking), the trajectory, and the path.

The prediction unit 22 according to the second embodiment performs the imitation learning using the manual driving by the driver of the mobile object 10 as training data so as to predict the behavior of the mobile object 10 when switching from the autonomous driving to the manual driving is made. Relevant examples of the imitation learning include the AgentRNN in the ChauffeurNet model described in Mayank Bansal, Alex Krizhevsky, Abhijit Ogale, “ChauffeurNet: Learning to Drive by Imitating the Best and Synthesizing the Worst”, [online], [site visited on Jul. 29, 2020], Available from Internet, <URL: https://arxiv.org/abs/1812.03079>. Using, for example, the AgentRNN, the prediction unit 22 acquires capability to output a trajectory similar to a driving trajectory of the training data through the learning.

In the second embodiment, the prediction unit 22 imitatively learns the manual driving. However, the prediction unit 22 may imitate the manual driving that does not satisfy safety standards defined for the autonomous driving. Therefore, the generation unit 21 according to the second embodiment generates the autonomous driving control information by modifying the imitation learning result representing the manual driving acquired by the imitation learning from the viewpoint of the safety standards. Specifically, the generation unit 21 performs modification processing to modify the manual driving acquired as the imitation learning result.

The modification processing checks whether the manual driving satisfies the safety standards. For example, the modification processing checks whether the manual driving violates the traffic rules (for example, the traffic signs and the legal speed limits). When checking the trajectory of the manual driving, whether, for example, the acceleration and angular acceleration of the mobile object 10 satisfy the safety is also checked.

If the manual driving does not satisfy the safety standards, the generation unit 21 modifies the manual driving. Specifically, the generation unit 21 uses a second-ranked candidate manual driving included in the imitation learning results, or changes the speeds at the waypoints of the manual driving trajectory, or regenerates the autonomous driving corresponding to the manual driving on the algorithm basis.

The manual driving can also be imitated by applying the generation processing of the autonomous driving control information by the generation unit 21, and changing parameters used in the generation processing. The parameters herein refer to parameters used for checking the safety of trajectory candidates. Examples of the parameters include the minimum distance between the trajectory and the obstacle, and the maximum acceleration and the maximum angular velocity when the own vehicle travels on the trajectory. The generation unit 21 applies a large safety factor to the parameters to minimize the possibility of accidents in the case of the autonomous driving, but reduces the safety factor in the case where the manual driving is imitated.

Finally, an example of a hardware configuration of a main part of the drive control device 20 according to each of the first and second embodiments will be described.

Example of Hardware Configuration

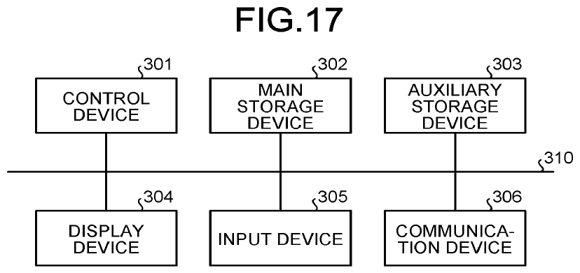

FIG. 17 is a diagram illustrating the example of the hardware configuration of the drive control device 20 according to each of the first and second embodiments. The drive control device 20 includes a control device 301, a main storage device 302, an auxiliary storage device 303, a display device 304, an input device 305, and a communication device 306. The main storage device 302, the auxiliary storage device 303, the display device 304, the input device 305, and the communication device 306 are connected together through a bus 310.

The drive control device 20 need not include the display device 304, the input device 305, and the communication device 306. For example, if the drive control device 20 is connected to another device, the drive control device 20 may use a display function, an input function, and a communication function of the other device.

The control device 301 executes a computer program read from the auxiliary storage device 303 into the main storage device 302. The control device 301 is one or a plurality of processors such as CPUs. The main storage device 302 is a memory such as a read-only memory (ROM) and a RAM. The auxiliary storage device 303 is, for example, a memory card and/or a hard disk drive (HDD).

The display device 304 displays information. The display device 304 is, for example, a liquid crystal display. The input device 305 receives input of the information. The input device 305 is, for example, hardware keys. The display device 304 and the input device 305 may be, for example, a liquid crystal touch panel that has both the display function and the input function. The communication device 306 communicates with other devices.

A computer program to be executed by the drive control device 20 is stored as a file in an installable format or an executable format on a computer-readable storage medium, such as a compact disc read-only memory (CD-ROM), a memory card, a compact disc-recordable (CD-R), or a digital versatile disc (DVD), and is provided as a computer program product.

The computer program to be executed by the drive control device 20 may be stored on a computer connected to a network such as the Internet, and provided by being downloaded through the network. The computer program to be executed by the drive control device 20 may be provided through the network such as the Internet without being downloaded.

The computer program to be executed by the drive control device 20 may be provided by being incorporated into, for example, a ROM in advance.

The computer program to be executed by the drive control device 20 has a module configuration including functions implementable by the computer program among the functions of the drive control device 20.

The functions to be implemented by the computer program are loaded into the main storage device 302 by causing the control device 301 to read the computer program from a storage medium such as the auxiliary storage device 303 and execute the computer program. That is, the functions to be implemented by the computer program are generated in the main storage device 302.

Some of the functions of the drive control device 20 may be implemented by hardware such as an IC. The IC is a processor that performs, for example, dedicated processing.

When a plurality of processors are used to implement the functions, each of the processors may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drive control device comprising:
a memory; and
one or more hardware processors electrically coupled to the memory and configured to function as:
a generation unit configured to generate autonomous driving control information to control a behavior of a mobile object using autonomous driving;
a prediction unit configured to predict a behavior of the mobile object when switching from the autonomous driving to manual driving is made;
a determination unit configured to determine a difference between the behavior of the mobile object controlled by the autonomous driving control information and the behavior of the mobile object when the switching to the manual driving is made;
an output control unit configured to output, to an output unit, information that prompts a driver of the mobile object to select the autonomous driving or the manual driving, when the difference is present; and
a power control unit configured to control a power unit of the mobile object using the autonomous driving or the manual driving.

2. The device according to claim 1, wherein the determination unit is configured to determine the difference based on at least one of a driving action of the mobile object, a path followed by the mobile object, and a trajectory of the mobile object.

3. The device according to claim 1, wherein
the determination unit is configured to further determine a time required to reach a destination using the autonomous driving and a time required to reach the destination when the switching to the manual driving is made, and
the output control unit is configured to output, to the output unit, information indicating that the manual driving enables reaching the destination earlier, in a case where the time required to reach the destination when the switching to the manual driving is made is shorter than the time required to reach the destination using the autonomous driving.

4. The device according to claim 1, wherein the output control unit is configured to output, to the output unit, output information in which at least one of information indicating a driving action of the autonomous driving, a speed of the mobile object when automatically driven, a path or a trajectory of the mobile object when automatically driven, the speed of the mobile object when manually driven, and a path or a trajectory of the mobile object when manually driven is highlighted.

5. The device according to claim 1, wherein the determination unit is configured to determine that the difference is present when the number of times that both a first condition and a second condition are satisfied is larger than a first threshold, the first condition is that a driving action of the mobile object when automatically driven does not agree with a driving action of the mobile object when manually driven, and the second condition is that a travel distance by the manual driving is larger than the travel distance by the autonomous driving.

6. The device according to claim 1, wherein
a trajectory or a path of the automatically driven mobile object is represented by a sequence of first waypoints representing positions, attitudes, and speeds of the mobile object,
a trajectory or a path of the manually driven mobile object is represented by a sequence of second waypoints representing positions, attitudes, and speeds of the mobile object, and
the determination unit is configured to calculate a differential between at least one of the positions, the attitudes, and the speeds represented by the first waypoints and at least one of the positions, the attitudes, and the speeds represented by the second waypoints corresponding to the first waypoints, and determine that the difference is present in a case where the number of times for which both a condition that the differential is larger than a second threshold and a condition that a travel distance by the manual driving is larger than the travel distance by the autonomous driving are determined to be satisfied is larger than a third threshold.

7. The device according to claim 1, wherein the determination unit is configured to use a first feature extraction network that extracts a first feature representing a feature of a trajectory or a path of the mobile object by the autonomous driving, a second feature extraction network that extracts a second feature representing a feature of a trajectory or a path of the mobile object by the manual driving, and a difference determination network that determines a difference between the first feature and the second feature so as to determine the difference between the behavior of the mobile object controlled to be automatically driven using the autonomous driving control information and the behavior of the mobile object when the switching to the manual driving is made.

8. The device according to claim 1, wherein
the prediction unit is configured to predict the behavior of the mobile object when the switching from the autonomous driving to the manual driving is made, with imitation learning using, as training data, the manual driving by a driver of the mobile object, and
the generation unit is configured to generate the autonomous driving control information by modifying an imitation learning result representing the manual driving, acquired by the imitation learning from a viewpoint of safety standards.

9. The device according to claim 1, wherein
the output control unit is configured to output, to the output unit, information for receiving setting of a safety margin between an obstacle and the mobile object, in a case where a driving action of the mobile object controlled to be automatically driven is stopping and a driving action of the mobile object in a case where the switching to the manual driving is made is an action other than the stopping,
the generation unit is configured to use the set safety margin to regenerate the autonomous driving control information, and
the power control unit is configured to control the power unit according to the regenerated autonomous driving control information, when a driving action indicated by the regenerated autonomous driving control information is an action other than the stopping.

10. The device according to claim 1, wherein
the output control unit is configured to output, to the output unit, output information that includes a path or a trajectory of the mobile object when automatically driven and a path or a trajectory of the mobile object when manually driven, and a message to check whether to use, in the autonomous driving, the path or the trajectory of the mobile object when manually driven,
the generation unit is configured to regenerate the autonomous driving control information based on the path or the trajectory of the mobile object when manually driven, in a case where the path or the trajectory of the mobile object when manually driven is to be used in the autonomous driving, and
the power control unit is configured to control the power unit according to the regenerated autonomous driving control information.

11. A drive control method comprising:
generating, by a drive control device, autonomous driving control information to control a behavior of a mobile object using autonomous driving;
predicting, by the drive control device, a behavior of the mobile object when switching from the autonomous driving to manual driving is made;
determining, by the drive control device, a difference between the behavior of the mobile object controlled to be automatically driven using the autonomous driving control information and the behavior of the mobile object when the switching to the manual driving is made;
outputting, to an output unit by the drive control device, information that prompts a driver of the mobile object to select the autonomous driving or the manual driving, when the difference is present; and
controlling, by the drive control device, a power unit of the mobile object using the autonomous driving or the manual driving.

12. The method according to claim 11, wherein at the determining, the difference is determined based on at least one of a driving action of the mobile object, a path followed by the mobile object, and a trajectory of the mobile object.

13. The method according to claim 11, wherein
at the determining, a time required to reach a destination using the autonomous driving and a time required to reach the destination when the switching to the manual driving is made are further determined, and
at the outputting, information indicating that the manual driving enables reaching the destination earlier is output to the output unit, in a case where the time required to reach the destination when the switching to the manual driving is made is shorter than the time required to reach the destination using the autonomous driving.

14. The method according to claim 11, wherein at the outputting, output information in which at least one of information indicating a driving action of the autonomous driving, a speed of the mobile object when automatically driven, a path or a trajectory of the mobile object when automatically driven, a speed of the mobile object when manually driven, and a path or a trajectory of the mobile object when manually driven is highlighted is output to the output unit.

15. The method according to claim 11, wherein at the determining, it is determined that the difference is present in a case where a number of times for which both a condition that a driving action of the mobile object when automatically driven does not agree with a driving action of the mobile object when manually driven and a condition that a travel distance by the manual driving is larger than the travel distance by the autonomous driving are determined to be satisfied is larger than a first threshold.

16. A computer program product having a non-transitory computer readable medium including programmed instructions, wherein the instructions, when executed by a computer, cause the computer to function as:
a generation unit configured to generate autonomous driving control information to control a behavior of a mobile object using autonomous driving;
a prediction unit configured to predict a behavior of the mobile object when switching from the autonomous driving to manual driving is made;
a determination unit configured to determine a difference between the behavior of the mobile object controlled to be automatically driven using the autonomous driving control information and the behavior of the mobile object when the switching to the manual driving is made;
an output control unit configured to output, to an output unit, information that prompts a driver of the mobile object to select the autonomous driving or the manual driving, when the difference is present; and
a power control unit configured to control a power unit of the mobile object using the autonomous driving or the manual driving.

17. The product according to claim 16, wherein the determination unit is configured to determine the difference based on at least one of a driving action of the mobile object, a path followed by the mobile object, and a trajectory of the mobile object.

18. The product according to claim 16, wherein
the determination unit is configured to further determine a time required to reach a destination using the autonomous driving and a time required to reach the destination when the switching to the manual driving is made, and
the output control unit is configured to output, to the output unit, information indicating that the manual driving enables reaching the destination earlier, in a case where the time required to reach the destination when the switching to the manual driving is made is shorter than the time required to reach the destination using the autonomous driving.

19. The product according to claim 16, wherein the output control unit is configured to output, to the output unit, output information in which at least one of information indicating a driving action of the autonomous driving, a speed of the mobile object when automatically driven, a path or a trajectory of the mobile object when automatically driven, the speed of the mobile object when manually driven, and a path or a trajectory of the mobile object when manually driven is highlighted.

20. The computer program according to claim 16, wherein the determination unit is configured to determine that the difference is present when the number of times that both a first condition and a second condition are satisfied is larger than a first threshold, the first condition is that a driving action of the mobile object when automatically driven does not agree with a driving action of the mobile object when manually driven, and the second condition is that a travel distance by the manual driving is larger than the travel distance by the autonomous driving.
